(19) United States
(12) Patent Application Publication
(10) Pub. No.: US 2021/0359330 A1
(43) Pub. Date: Nov. 18, 2021

(54) REDOX FLOW BATTERY

(71) Applicant: Panasonic Intellectual Property Management Co., Ltd., Osaka (JP)

(72) Inventors: HONAMI SAKO, Osaka (JP); MASAHISA FUJIMOTO, Osaka (JP); SHUJI ITO, Nara (JP)

(21) Appl. No.: 17/386,025

(22) Filed: Jul. 27, 2021

Related U.S. Application Data
(63) Continuation of application No. PCT/JP2020/019198, filed on May 14, 2020.

(30) Foreign Application Priority Data
Jun. 27, 2019 (JP) 2019-119400

(51) Int. Cl. H01M 8/18; H01M 8/1023; H01M 8/1039; H01M 4/36; H01M 4/60

(52) U.S. Cl. CPC H01M 8/188; H01M 8/1023; H01M 2008/1095; H01M 4/368; H01M 4/60; H01M 8/1039

(57) ABSTRACT

A redox flow battery includes a negative electrode; a positive electrode; a first liquid which contains a first nonaqueous solvent, a first redox species, and metal ions and which is in contact with the negative electrode; a second liquid which contains a second nonaqueous solvent and which is in contact with the positive electrode; and a metal ion-conducting membrane which is disposed between the first liquid and the second liquid and which is nonporous. The metal ion-conducting membrane is swollen by at least one selected from the group consisting of the first liquid and the second liquid and allows the metal ions to pass therethrough.

### BACKGROUND

### 1. Technical Field

The present disclosure relates to a redox flow battery.

### 2. Description of the Related Art

Japanese Unexamined Patent Application Publication (Translation of PCT Application) No. 2014-524124 discloses a redox flow battery system including an energy reservoir containing a redox mediator.

International Publication No. 2016/208123 discloses a redox flow battery containing a redox species.

Japanese Unexamined Patent Application Publication (Translation of PCT Application) No. 2014-503946 discloses a redox flow battery including a porous separation membrane containing an organic polymer.

### SUMMARY

One non-limiting and exemplary embodiment provides a redox flow battery in which a reduction in capacity due to the crossover of redox species is suppressed.

In one general aspect, the techniques disclosed here feature a redox flow battery including a negative electrode; a positive electrode; a first liquid which contains a first nonaqueous solvent, a first redox species, and metal ions and which is in contact with the negative electrode; a second liquid which contains a second nonaqueous solvent and which is in contact with the positive electrode; and a metal ion-conducting membrane which is disposed between the first liquid and the second liquid and which is nonporous. The metal ion-conducting membrane is swollen by at least one selected from the group consisting of the first liquid and the second liquid and allows the metal ions to pass therethrough.

According to the present disclosure, a redox flow battery in which a reduction in capacity due to the crossover of redox species is suppressed can be provided.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view showing the schematic configuration of a redox flow battery according to an embodiment of the present disclosure;

FIG. 2 is an illustration showing the operation of the redox flow battery shown in FIG. 1;

FIG. 3 is a graph showing the adsorption isotherm of a nitrogen gas on a metal ion-conducting membrane of Example 1;

FIG. 4 is a graph showing the pore size distribution of the metal ion-conducting membrane obtained in Example 1 and the pore size distribution of mesoporous silica; and

FIG. 5 is a graph showing the open-circuit voltage of the electrochemical cells of Example 1, Example 2, and Comparative Example 1.

### DETAILED DESCRIPTION

### Summary of Aspects of Present Disclosure

A redox flow battery according to a first aspect of the present disclosure includes a negative electrode; a positive electrode; a first liquid which contains a first nonaqueous solvent, a first redox species, and metal ions and which is in contact with the negative electrode; a second liquid which contains a second nonaqueous solvent and which is in contact with the positive electrode; and a metal ion-conducting membrane which is disposed between the first liquid and the second liquid and which is nonporous. The metal ion-conducting membrane is swollen by at least one selected from the group consisting of the first liquid and the second liquid and allows the metal ions to pass therethrough.

According to the first aspect, the metal ion-conducting membrane is swollen by at least one selected from the group consisting of the first liquid and the second liquid and allows the metal ions to pass therethrough. On the other hand, the metal ion-conducting membrane is nonporous and therefore hardly allows the first redox species to pass therethrough. This enables a crossover that the first redox species moves from the first liquid to the second liquid to be suppressed. Suppressing the crossover enables the redox flow battery to maintain high capacity over a long period of time.

In a second aspect of the present disclosure, in the redox flow battery according to, for example, the first aspect, the adsorption isotherm of a nitrogen gas on the metal ion-conducting membrane may belong to Type H or HI according to the IUPAC classification.

In a third aspect of the present disclosure, in the redox flow battery according to, for example, the first or second aspect, the metal ion-conducting membrane may contain an organic polymer.

In a fourth aspect of the present disclosure, in the redox flow battery according to, for example, the third aspect, the organic polymer may include at least one selected from the group consisting of polyolefins and fluorinated polyolefins.

In a fifth aspect of the present disclosure, in the redox flow battery according to, for example, the third or fourth aspect, the organic polymer may include at least one selected from the group consisting of polyvinylidene fluoride, polyethylene, and polypropylene.

In a sixth aspect of the present disclosure, in the redox flow battery according to, for example, any one of the first to fifth aspects, the metal ions may include at least one selected from the group consisting of lithium ions, sodium ions, magnesium ions, and aluminium ions.

According to the second to sixth aspects, the redox flow battery can maintain high capacity over a long period of time.

In a seventh aspect of the present disclosure, the redox flow battery according to, for example, any one of the first to sixth aspects may further include a negative electrode active material in contact with the first liquid and a first circulation mechanism configured to circulate the first liquid between the negative electrode and the negative electrode active material, and the first redox species may be oxidized or reduced by the negative electrode and may be oxidized or reduced by the negative electrode active material. According to the seventh aspect, the redox flow battery has high volume energy density.

In an eighth aspect of the present disclosure, the redox flow battery according to, for example, any one of the first to seventh aspects may further include a negative electrode active material in contact with the first liquid, the first redox species may be an aromatic compound, the metal ions may be lithium ions, the first liquid may dissolve lithium, the negative electrode active material may have the property of storing or releasing lithium ions, the first liquid may have a potential of less than or equal to 0.5 V vs. Li⁺/Li, and the metal ion-conducting membrane may contain an organic polymer as a major component. According to the eighth aspect, since the potential of the first liquid is low, the redox flow battery exhibits high discharge voltage. Therefore, the redox flow battery has high volume energy density.

In a ninth aspect of the present disclosure, in the redox flow battery according to, for example, the eighth aspect, the aromatic compound may include at least one selected from the group consisting of biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, and benzil.

In a tenth aspect of the present disclosure, the redox flow battery according to, for example, any one of the first to ninth aspects may further include a positive electrode active material in contact with the second liquid, the second liquid may contain a second redox species, and the second redox species may be oxidized or reduced by the positive electrode and may be oxidized or reduced by the positive electrode active material.

In an eleventh aspect of the present disclosure, in the redox flow battery according to, for example, the tenth aspect, the second redox species may include at least one selected from the group consisting of tetrathiafulvalene, triphenylamine, and derivatives thereof.

In a twelfth aspect of the present disclosure, in the redox flow battery according to, for example, any one of the first to eleventh aspects, each of the first nonaqueous solvent and the second nonaqueous solvent may include a compound containing at least one selected from the group consisting of carbonate groups and ether bonds.

In a thirteenth aspect of the present disclosure, in the redox flow battery according to, for example, the twelfth aspect, each of the first nonaqueous solvent and the second nonaqueous solvent may include at least one selected from the group consisting of propylene carbonate, ethylene carbonate, dimethyl carbonate, ethyl methyl carbonate, and diethyl carbonate.

In a fourteenth aspect of the present disclosure, in the redox flow battery according to, for example, the twelfth aspect, each of the first nonaqueous solvent and the second nonaqueous solvent may include at least one selected from the group consisting of dimethoxyethane, diethoxyethane, dibutoxyethane, diglyme, triglyme, tetraglyme, polyethylene glycol dialkyl ethers, tetrahydrofuran, 2-methyltetrahydrofuran, 2,5-dimethyltetrahydrofuran, 1,3-dioxolane, and 4-methyl-1,3-dioxolane.

According to the ninth to fourteenth aspects, the redox flow battery exhibits high discharge voltage. Therefore, the redox flow battery has high volume energy density.

Embodiments of the present disclosure are described below with reference to the accompanying drawings. The present disclosure is not limited to the embodiments below.

### EMBODIMENTS

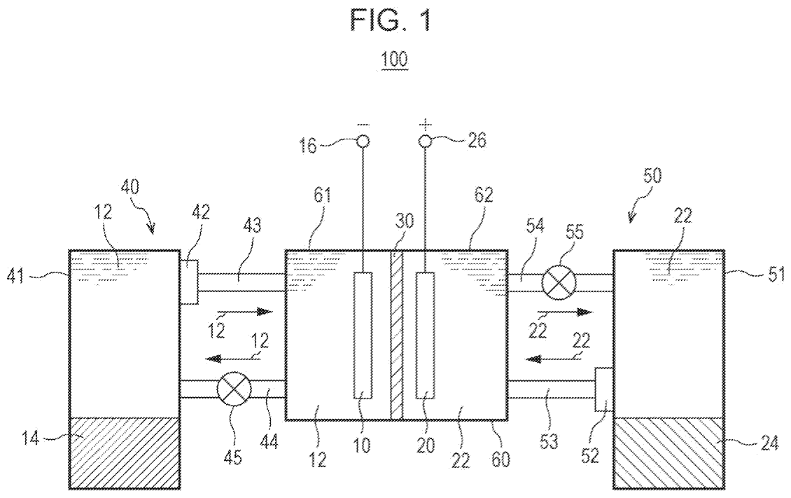

FIG. 1 is a schematic view showing the schematic configuration of a redox flow battery 100 according to an embodiment of the present disclosure. As shown in FIG. 1, the redox flow battery 100 includes a negative electrode 10, a positive electrode 20, a first liquid 12, a second liquid 22, and a metal ion-conducting membrane 30. The redox flow battery 100 may further include a negative electrode active material 14. The first liquid 12 contains a first nonaqueous solvent, a first redox species 18, and metal ions. The first liquid 12 is in contact with, for example, each of the negative electrode 10 and the negative electrode active material 14. In other words, each of the negative electrode 10 and the negative electrode active material 14 is immersed in the first liquid 12. At least a portion of the negative electrode 10 is in contact with the first liquid 12. The second liquid 22 contains a second nonaqueous solvent. The second liquid 22 is in contact with the positive electrode 20. In other words, the positive electrode 20 is immersed in the second liquid 22. At least a portion of the positive electrode 20 is in contact with the second liquid 22. The metal ion-conducting membrane 30 is disposed between the first liquid 12 and the second liquid 22 and isolates the first liquid 12 from the second liquid 22. The metal ion-conducting membrane 30 has a first surface in contact with the first liquid 12 and a second surface in contact with the second liquid 22.

In the redox flow battery 100 according to the present embodiment, the metal ion-conducting membrane 30 is nonporous. In particular, the metal ion-conducting membrane 30 in a dry state is nonporous. The term “nonporous” means that no pores communicating between the first surface and second surface of the metal ion-conducting membrane 30 are present. The fact that the metal ion-conducting membrane 30 is nonporous can be determined from, for example, the adsorption isotherm of a nitrogen gas on the metal ion-conducting membrane 30. When the adsorption isotherm of a nitrogen gas on the metal ion-conducting membrane 30 belongs to, for example, Type H or 1H according to the IUPAC classification, the metal ion-conducting membrane 30 can be determined as being nonporous. The adsorption isotherm of a nitrogen gas can be obtained in such a manner that, for example, a gas adsorption method is performed for the metal ion-conducting membrane 30 at 25° C. using a nitrogen gas. The term “IUPAC classification of adsorption isotherms” refers to the classification of standard physical adsorption isotherms defined by IUPAC.

The fact that the metal ion-conducting membrane 30 is nonporous can also be determined from the comparison of the pore size distribution of the metal ion-conducting membrane 30 with the pore size distribution of a porous material. In particular, the fact that no peak is present in the pore size distribution of the metal ion-conducting membrane 30 can be confirmed on the basis of peak intensity in the pore size distribution of the porous material. The porous material used may be, for example, mesoporous silica. The pore size distribution of the metal ion-conducting membrane 30 and the pore size distribution of the porous material are determined by, for example, the same method. These pore size distributions are obtained in such a manner that, for example, data on adsorption isotherms obtained by a gas adsorption method using a nitrogen gas is converted by the Barrett-Joyner-Halenda (BJH) technique, Data on an adsorption isotherm may be obtained by a gas adsorption method using an argon gas. The fact that the metal ion-conducting membrane 30 is nonporous can also be determined by methods such as a mercury intrusion method, direct observation with an electron microscope, and a positron annihilation method.

Since the metal ion-conducting membrane 30 is nonporous, the specific surface area of the metal ion-conducting membrane 30 is relatively small. The specific surface area of the metal ion-conducting membrane 30 is, for example, less than 0.5 m²/g as determined by the Brunauer-Emmett-Teller (BET) method using nitrogen gas adsorption.

The metal ion-conducting membrane 30 is swollen by at least one selected from the group consisting of the first liquid 12 and the second liquid 22 and allows the metal ions to pass therethrough. The term “swell” as used herein means that the metal ion-conducting membrane 30 absorbs a portion of the first nonaqueous solvent, which is contained in the first liquid 12, or the second nonaqueous solvent, which is contained in the second liquid 22, and therefore the volume or weight of the metal ion-conducting membrane 30 increases. The material of the metal ion-conducting membrane 30 is not particularly limited as long as the material has such properties. The metal ion-conducting membrane 30 contains, for example, an organic polymer. The metal ion-conducting membrane 30 may contain the organic polymer as a major component. The term “major component” refers to a component present in the largest amount on a weight basis in the metal ion-conducting membrane 30. The content of the organic polymer in the metal ion-conducting membrane 30 may be greater than or equal to 50% by weight. The metal ion-conducting membrane 30 may consist essentially of the organic polymer. The phrase “consist essentially of” means that another component varying an essential feature of the referred material is excluded. Incidentally, the metal ion-conducting membrane 30 may contain an impurity in addition to the organic polymer. The metal ion-conducting membrane 30 contains substantially no metal ions in such a state that the metal ion-conducting membrane 30 is out of contact with the first liquid 12 or the second liquid 22.

The organic polymer includes, for example, at least one selected from the group consisting of polyolefins and fluorinated polyolefins. The organic polymer may contain a polyolefin or a fluorinated polyolefin as a major component. In this case, the organic polymer is almost insoluble in the first liquid 12 or the second liquid 22 and is almost unreactive with the first liquid 12 or the second liquid 22. The polyolefin is a polymer composed of structural units derived from one or more olefins. Examples of the olefins include ethylene and propylene. Examples of the polyolefin include polyethylene and polypropylene.

The term “fluorinated polyolefin” refers to a polyolefin in which at least one hydrogen atom is substituted by a fluorine atom. The fluorinated polyolefin is, for example, a polymer composed of structural units derived from one or more fluorinated olefins. Incidentally, the fluorinated polyolefin may further contain structural units derived from an olefin in addition to structural units derived from a fluorinated olefin. Examples of the fluorinated olefin include vinylidene fluoride, vinyl fluoride, and tetrafluoroethylene. Examples of the fluorinated polyolefin include polyvinylidene fluoride. As the degree of fluorination of the fluorinated polyolefin is lower, the organic polymer is less likely to be degraded by the first liquid 12.

The organic polymer includes, for example, at least one selected from the group consisting of polyvinylidene fluoride, polyethylene, and polypropylene. The organic polymer may contain polyvinylidene fluoride, polyethylene, or polypropylene as a major component. In this case, even when the first liquid 12 exhibits a very low potential of less than or equal to 0.5 V vs. Li⁺/Li and has high reducing power, the organic polymer is almost unreactive with the first liquid 12 and has high durability. The organic polymer may consist essentially of polyvinylidene fluoride, polyethylene, or polypropylene or may consist essentially of polyvinylidene fluoride.

The weight-average molecular weight of the organic polymer is not particularly limited and is, for example, greater than or equal to 10,000 and less than or equal to 500,000.

The metal ion-conducting membrane 30 may further contain a porous support in addition to the organic polymer. In the metal ion-conducting membrane 30, the pores of the porous support may be filled with the organic polymer. Examples of the porous support include nonwoven fabrics, filter paper, and separators.

Since the metal ion-conducting membrane 30 contains the organic polymer, the metal ion-conducting membrane 30 has flexibility. Furthermore, the organic polymer is swollen due to the contact of the first liquid 12 or the second liquid 22 with the metal ion-conducting membrane 30. This enlarges a space between two neighboring molecules of the organic polymer. The swelling of the organic polymer enlarges the three-dimensional structure of a molecular chain contained in the organic polymer. Therefore, the radius of inertia of the organic polymer that is determined by the three-dimensional structure of the molecular chain also increases. The radius of inertia of the organic polymer can be calculated from molecular dynamics computer simulations. In the swollen metal ion-conducting membrane 30, the size of the space between the two neighboring organic polymer molecules is, for example, greater than the size of the metal ions and less than the size of the first redox species 18 solvated with the first nonaqueous solvent. In this case, the passage of the metal ions through the metal ion-conducting membrane 30 can be ensured and a crossover that the first redox species 18 moves to the second liquid 22 can be sufficiently suppressed. Suppressing the crossover of the first redox species 18 to the second liquid 22 enables the concentration of the first redox species 18 in the first liquid 12 to be maintained. Therefore, the charge/discharge capacity of the redox flow battery 100 can be maintained over a long period of time.

In the redox flow battery 100 according to the present embodiment, the metal ions include, for example, at least one selected from the group consisting of lithium ions, sodium ions, magnesium ions, and aluminium ions. The size of the metal ions varies depending on coordination with a solvent or another ion species. In the specification, the size of the metal ions means, for example, the diameter of the metal ions. For example, the diameter of a lithium ion is greater than or equal to 0.12 nm and less than or equal to 0.18 nm. The diameter of a sodium ion is greater than or equal to 0.20 nm and less than or equal to 0.28 nm. The diameter of a magnesium ion is greater than or equal to 0.11 nm and less than or equal to 0.18 nm. The diameter of an aluminium ion is greater than or equal to 0.08 nm and less than or equal to 0.11 nm. Therefore, when the average size of the space between the two neighboring organic polymer molecules in the swollen metal ion-conducting membrane 30 is greater than or equal to 0.5 nm, the passage of these metal ions can be sufficiently ensured. Incidentally, the size of the space between the two neighboring organic polymer molecules means, for example, the diameter of the maximum sphere that can be contained within the space therebetween.

In the redox flow battery 100 according to the present embodiment, the first redox species 18 is, for example, an aromatic compound as described below. The size of the first redox species 18 itself and the size of the first redox species 18 solvated with the first nonaqueous solvent can be calculated by, for example, first-principles calculation using the density functional method B3LYP/6-31G. In the specification, the size of the first redox species 18 solvated with the first nonaqueous solvent means, for example, the diameter of the minimum sphere that can enclose the first redox species 18 solvated with the first nonaqueous solvent. The size of the first redox species 18 itself is greater than or equal to, for example, about 1 nm. The size of the first redox species 18 solvated with the first nonaqueous solvent varies depending on the type of the first nonaqueous solvent, the coordination state of the first nonaqueous solvent, or the like and is greater than, for example, 5 nm. The upper limit of the size of the first redox species 18 solvated with the first nonaqueous solvent is not particularly limited and is, for example, 8 nm. Therefore, when the size of the space between the two neighboring organic polymer molecules in the swollen metal ion-conducting membrane 30 is less than or equal to 5 nm, the passage of the first redox species 18 solvated with the first nonaqueous solvent can be sufficiently suppressed. The coordination state and coordination number of the first nonaqueous solvent for the first redox species 18 can be estimated from, for example, results of the NMR measurement of the first liquid 12.

In the first liquid 12, a plurality of molecules of the first redox species 18 solvated with the first nonaqueous solvent aggregate to form clusters in some cases. That is, the clusters, which contain molecules of the first redox species 18 solvated with the first nonaqueous solvent, are dispersed in the first liquid 12 and migrate in some cases. Therefore, when the size of the space between the two neighboring organic polymer molecules in the swollen metal ion-conducting membrane 30 is less than the size of the clusters, a crossover that the first redox species 18 moves to the second liquid 22 can be suppressed in some cases. For example, the size of the space between the two neighboring organic polymer molecules in the swollen metal ion-conducting membrane 30 may be less than the size of a cluster containing two molecules of the first redox species 18 solvated with the first nonaqueous solvent or may be less than the size of a cluster containing four molecules of the first redox species 18 solvated with the first nonaqueous solvent. The size of the clusters can be calculated by, for example, the same method as the method for calculating the size of the first redox species 18.

As long as the metal ion-conducting membrane 30 is nonporous and has sufficient permeability for the metal ions with respect to the operation of the redox flow battery 100 and the mechanical strength of the metal ion-conducting membrane 30 can be ensured, a cavity may be present in the metal ion-conducting membrane 30. The porosity of the metal ion-conducting membrane 30 is not particularly limited and may be less than or equal to 20% or may be less than or equal to 10%. The porosity of the metal ion-conducting membrane 30 can be measured by, for example, a method below. First, the volume V and weight W of the metal ion-conducting membrane 30 are measured. The porosity thereof can be calculated in such a manner that the obtained volume V, the obtained weight W, and the density D of the material of the metal ion-conducting membrane 30 are substituted into the following equation:

Porosity(%)=100×(V−(W/D))/V.

As long as the metal ion-conducting membrane 30 has sufficient permeability for the metal ions with respect to the operation of the redox flow battery 100 and the mechanical strength of the metal ion-conducting membrane 30 can be ensured, the thickness of the metal ion-conducting membrane 30 is not particularly limited. The thickness of the metal ion-conducting membrane 30 may be greater than or equal to 10 μm and less than or equal to 1 mm, may be greater than or equal to 10 μm and less than or equal to 500 μm, or may be greater than or equal to 50 μm and less than or equal to 200 μm.

A method for manufacturing the metal ion-conducting membrane 30 is not particularly limited. When the metal ion-conducting membrane 30 is made of polyvinylidene fluoride, the metal ion-conducting membrane 30 can be prepared by, for example, a method below. First, polyvinylidene fluoride is dissolved in an organic solvent such as N-methylpyrrolidone (NMP), whereby a solution is prepared. The obtained solution is applied to a glass substrate. The obtained coating is dried and is then peeled away from the glass substrate, whereby the metal ion-conducting membrane 30 is obtained. The solution may be applied to a porous support, such as a nonwoven fabric or a separator, placed on the glass substrate.

In the redox flow battery 100, the first liquid 12 functions as an electrolyte solution. The first nonaqueous solvent, which is contained in the first liquid 12, includes, for example, a compound containing at least one selected from the group consisting of a carbonate group and an ether bond. The first nonaqueous solvent may include at least one selected from the group consisting of propylene carbonate (PC), ethylene carbonate (EC), dimethyl carbonate (DMC), ethyl methyl carbonate (EMC), and diethyl carbonate (DEC) as a carbonate group-containing compound. The first nonaqueous solvent may contain at least one selected from the group consisting of dimethoxyethane, diethoxyethane, dibutoxyethane, diglyme (diethylene glycol dimethyl ether), triglyme (triethylene glycol dimethyl ether), tetraglyme (tetraethylene glycol dimethyl ether), polyethylene glycol dialkyl ethers, tetrahydrofuran, 2-methyltetrahydrofuran, 2,5-dimethyltetrahydrofuran, 1,3-dioxolane, and 4-methyl-1,3-dioxolane as an ether bond-containing compound.

The first redox species 18, which is contained in the first liquid 12, can be dissolved in the first liquid 12. The first redox species 18 is electrochemically oxidized or reduced by the negative electrode 10 and is electrochemically oxidized or reduced by the negative electrode active material 14. In other words, the first redox species 18 functions as a negative electrode mediator. When the redox flow battery 100 includes no negative electrode active material 14, the first redox species 18 functions as an active material that is oxidized or reduced by the negative electrode 10 only.

The first redox species 18 includes, for example, an organic compound that dissolves lithium as cations. The organic compound may be an aromatic compound or a condensed aromatic compound. The first redox species 18 includes, for example, at least one selected from the group consisting of biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, and benzil as an aromatic compound. The molecular weight of the first redox species 18 is not particularly limited and may be greater than or equal to 100 and less than or equal to 500 or may be greater than or equal to 100 and less than or equal to 301.

When the first redox species 18 used is the aromatic compound and lithium is dissolved in the first liquid 12, the first liquid 12 exhibits a very low potential of less than or equal to 0.5 V vs. Li⁺/Li in some cases. Combining the first liquid 12 with a second liquid 22 which exhibits a potential of greater than or equal to 2.5 V vs. Li⁺/Li allows the redox flow battery 100 to exhibit a battery voltage of greater than or equal to 3.0 V. This allows the redox flow battery 100 to have high energy density. In this case, the first liquid 12 has very high reducing power. From the viewpoint of sufficiently ensuring durability against the first liquid 12, the organic polymer, which contains polyvinylidene fluoride or polypropylene as a major component, is suitable for the metal ion-conducting membrane 30.

As described above, the metal ions, which are contained in the first liquid 12, include, for example, at least one selected from the group consisting of lithium ions, sodium ions, magnesium ions, and aluminium ions. The metal ions are, for example, lithium ions.

The first liquid 12 may further contain an electrolyte. The electrolyte is, for example, at least one selected from the group consisting of LiBF₄, LiPF₆, lithium bis(trifluoromethanesulfonyl)imide (LiTFSI), lithium bis(fluorosulfonyl)imide (LiFSI), LiCF₃SO₃, LiClO₄, NaBF₄, NaPF₆, NaTFSI, NaFSI, NaCF₃SO₃, NaClO₄, Mg(BF₄)₂, Mg(PF₆)₂, Mg(TFSI)₂, Mg(FSI)₂, Mg(CF₃SO₃)₂, Mg(ClO₄)₂, AlCl₃, AlBr₃, and Al(TFSI)₃. The first liquid 12 may have a high dielectric constant and may further have a potential window of less than or equal to about 4V depending on the electrolyte.

The negative electrode 10 has, for example, a surface acting as a reaction field for the first redox species 18. The material of the negative electrode 10 is stable to, for example, the first liquid 12. The material of the negative electrode 10 may be insoluble in the first liquid 12. The material of the negative electrode 10 is also stable to, for example, an electrochemical reaction which is an electrode reaction. The material of the negative electrode 10 may be metal, carbon, or the like. Examples of metal used as the material of the negative electrode 10 include stainless steel, iron, copper, and nickel.

The negative electrode 10 may have a structure with an increased surface area. Examples of such a structure with an increased surface area include meshes, nonwoven fabrics, surface-roughened plates, and sintered porous bodies. When the negative electrode 10 has such a structure, the negative electrode 10 has a large specific surface area. Therefore, the oxidation reaction or reduction reaction of the first redox species 18 in the negative electrode 10 proceeds readily.

In the redox flow battery 100, at least a portion of the negative electrode active material 14 is in contact with the first liquid 12, The negative electrode active material 14 is insoluble in, for example, the first liquid 12. The negative electrode active material 14 can reversibly store or release the metal ions. The material of the negative electrode active material 14 may be metal, a metal oxide, carbon, silicon, or the like. The metal may be lithium, sodium, magnesium, aluminium, tin, or the like. The metal oxide may be titanium oxide or the like. When the first redox species 18 is the aromatic compound and lithium is dissolved in the first liquid 12, the negative electrode active material 14 may contain at least one selected from the group consisting of carbon, silicon, aluminium, and tin.

The shape of the negative electrode active material 14 is not particularly limited and the negative electrode active material 14 may be granular, powdery, or pellet-shaped. The negative electrode active material 14 may be bound with a binder. Examples of the binder include resins such as polyvinylidene fluoride, polypropylene, polyethylene, and polyimide.

When the redox flow battery 100 includes the negative electrode active material 14, the charge/discharge capacity of the redox flow battery 100 does not depend on the solubility of the first redox species 18 but depends on the capacity of the negative electrode active material 14. Therefore, the redox flow battery 100 can be readily achieved so as to have high energy density.

In the redox flow battery 100, the second liquid 22 functions as an electrolyte solution. The second nonaqueous solvent includes, for example, a compound containing at least one selected from the group consisting of a carbonate group and an ether bond. The second nonaqueous solvent may include at least one selected from the group consisting of propylene carbonate, ethylene carbonate, dimethyl carbonate, ethyl methyl carbonate, and diethyl carbonate as a carbonate group-containing compound. The second nonaqueous solvent may include at least one selected from the group consisting of dimethoxyethane, diethoxyethane, dibutoxyethane, diglyme, triglyme, tetraglyme, polyethylene glycol dialkyl ethers, tetrahydrofuran, 2-methyltetrahydrofuran, 2,5-dimethyltetrahydrofuran, 1,3-dioxolane, and 4-methyl-1,3-dioxolane as an ether bond-containing compound. The second nonaqueous solvent may be the same as or different from the first nonaqueous solvent.

The second liquid 22 may further contain a second redox species 28. In this case, the redox flow battery 100 may further include a positive electrode active material 24 in contact with the second liquid 22. When the redox flow battery 100 includes the positive electrode active material 24, the second redox species 28 functions as a positive electrode mediator. The second redox species 28 is dissolved in, for example, the second liquid 22. The second redox species 28 is oxidized or reduced by the positive electrode 20 and is oxidized or reduced by the positive electrode active material 24. When the redox flow battery 100 includes no positive electrode active material 24, the second redox species 28 functions as an active material that is oxidized or reduced by the positive electrode 20 only.

The second redox species 28 includes, for example, at least one selected from the group consisting of tetrathiafulvalene, triphenylamine, and derivatives thereof. The second redox species 28 may be, for example, a metallocene compound such as ferrocene or titanocene. The second redox species 28 may be a heterocyclic compound such as a bipyridyl derivative, a thiophene derivative, a thianthrene derivative, a carbazole derivative, or a phenanthroline derivative. The second redox species 28 used may be a combination of two or more of these derivatives as required.

The size of the space between the two neighboring organic polymer molecules in the swollen metal ion-conducting membrane 30 is less than, for example, the size of the second redox species 28 solvated with the second nonaqueous solvent. In this case, a crossover that the second redox species 28 moves to the first liquid 12 can be sufficiently suppressed. The size of the space between the two neighboring organic polymer molecules in the swollen metal ion-conducting membrane 30 is less than, for example, the minimum one of the size of the first redox species 18 solvated with the first nonaqueous solvent and the size of the second redox species 28 solvated with the second nonaqueous solvent.

The size of the second redox species 28 solvated with the second nonaqueous solvent can be calculated by, for example, first-principles calculation using the density functional method B3LYP/6-31G as is the case with the first redox species 18. In the specification, the size of the second redox species 28 solvated with the second nonaqueous solvent means, for example, the diameter of the minimum sphere that can enclose the second redox species 28 solvated with the second nonaqueous solvent. The coordination state and coordination number of the second nonaqueous solvent for the second redox species 28 can be estimated from, for example, results of the NMR measurement of the second liquid 22.

In the redox flow battery 100 according to the present embodiment, the range of options for the first liquid 12, the first redox species 18, the second liquid 22, and the second redox species 28 is wide. Therefore, the control range of the charge potential and discharge potential of the redox flow battery 100 is wide, and the charge capacity of the redox flow battery 100 can be readily increased. Furthermore, the first liquid 12 and the second liquid 22 are almost unmixed due to the metal ion-conducting membrane 30. Therefore, charge/discharge characteristics of the redox flow battery 100 can be maintained over a long period of time.

The positive electrode 20 has, for example, a surface acting as a reaction field for the second redox species 28. The material of the positive electrode 20 is stable to, for example, the second liquid 22. The material of the positive electrode 20 may be insoluble in the second liquid 22. The material of the positive electrode 20 is also stable to, for example, an electrochemical reaction. The material of the positive electrode 20 may be the material exemplified for the negative electrode 10. The material of the positive electrode 20 may be the same as or different from the material of the negative electrode 10.

The positive electrode 20 may have a structure with an increased surface area. Examples of such a structure with an increased surface area include meshes, nonwoven fabrics, surface-roughened plates, and sintered porous bodies. When the positive electrode 20 has such a structure, the positive electrode 20 has a large specific surface area. Therefore, the oxidation or reduction reaction of the second redox species 28 in the positive electrode 20 proceeds readily.

When the second liquid 22 contains the second redox species 28, the redox flow battery 100 may further include the positive electrode active material 24 as described above. At least a portion of the positive electrode active material 24 is in contact with the second liquid 22. The positive electrode active material 24 is insoluble in, for example, the second liquid 22. The positive electrode active material 24 can reversibly store or release the metal ions, Examples of the positive electrode active material 24 include metal oxides such as lithium iron phosphate, LiCoO₂ (LCO), LiMn₂O₄ (LMO), and lithium-nickel-cobalt-aluminium composite oxide (NCA).

The shape of the positive electrode active material 24 is not particularly limited and the positive electrode active material 24 may be granular, powdery, or pellet-shaped. The positive electrode active material 24 may be bound with a binder. Examples of the binder include resins such as polyvinylidene fluoride, polypropylene, polyethylene, and polyimide.

When the redox flow battery 100 includes the negative electrode active material 14 and the positive electrode active material 24, the charge/discharge capacity of the redox flow battery 100 does not depend on the solubility of the first redox species 18 or the second redox species 28 but depends on the capacity of the negative electrode active material 14 and the positive electrode active material 24. Therefore, the redox flow battery 100 can be readily achieved so as to have high energy density.

The redox flow battery 100 may further include an electrochemical reaction section 60, a negative electrode terminal 16, and a positive electrode terminal 26. The electrochemical reaction section 60 includes a negative electrode compartment 61 and a positive electrode compartment 62. The metal ion-conducting membrane 30 is disposed in the electrochemical reaction section 60. In the inside of the electrochemical reaction section 60, the metal ion-conducting membrane 30 separates the negative electrode compartment 61 from the positive electrode compartment 62.

The negative electrode compartment 61 contains the negative electrode 10 and the first liquid 12. In the inside of the negative electrode compartment 61, the negative electrode 10 is in contact with the first liquid 12. The positive electrode compartment 62 contains the positive electrode 20 and the second liquid 22. In the inside of the positive electrode compartment 62, the positive electrode 20 is in contact with the second liquid 22.

The negative electrode terminal 16 is electrically connected to the negative electrode 10. The positive electrode terminal 26 is electrically connected to the positive electrode 20. The negative electrode terminal 16 and the positive electrode terminal 26 are electrically connected to, for example, a charge-discharge device. The charge-discharge device can apply a voltage to the redox flow battery 100 through the negative electrode terminal 16 and the positive electrode terminal 26. The charge-discharge device can draw electricity from the redox flow battery 100 through the negative electrode terminal 16 and the positive electrode terminal 26.

The redox flow battery 100 may further include a first circulation mechanism 40 and a second circulation mechanism 50. The first circulation mechanism 40 includes a first storage section 41, a first filter 42, a pipe 43, a pipe 44, and a pump 45. The first storage section 41 stores the negative electrode active material 14 and the first liquid 12. In the inside of the first storage section 41, the negative electrode active material 14 is in contact with the first liquid 12. For example, the first liquid 12 is present in a cavity in the negative electrode active material 14. The first storage section 41 is, for example, a tank.

The first filter 42 is disposed at an outlet of the first storage section 41. The first filter 42 may be disposed at an inlet of the first storage section 41 or may be disposed at an inlet or outlet of the negative electrode compartment 61. The first filter 42 may be disposed in the pipe 43 as described below. The first filter 42 allows the first liquid 12 to pass therethrough and suppresses the passage of the negative electrode active material 14. When the negative electrode active material 14 is granular, the first filter 42 has, for example, pores smaller than the particle size of the negative electrode active material 14. The material of the first filter 42 is not particularly limited as long as the material is almost unreactive with the negative electrode active material 14 or the first liquid 12. Examples of the first filter 42 include glass fiber filter paper, polypropylene nonwoven fabrics, polyethylene nonwoven fabrics, polyethylene separators, polypropylene separators, polyimide separators, separators with a polyethylene/polypropylene two-layer structure, separators with a polypropylene/polyethylene/polypropylene three-layer structure, and metal meshes unreactive with metallic lithium. According to the first filter 42, the leakage of the negative electrode active material 14 from the first storage section 41 can be suppressed. This allows the negative electrode active material 14 to remain in the first storage section 41. In the redox flow battery 100, the negative electrode active material 14 itself does not circulate. Therefore, the inside of the pipe 43 or the like is unlikely to be clogged with the negative electrode active material 14. According to the first filter 42, the occurrence of resistance loss due to the leakage of the negative electrode active material 14 into the negative electrode compartment 61 can also be suppressed.

The pipe 43 is connected to, for example, the outlet of the first storage section 41 with the first filter 42 therebetween. The pipe 43 has an end connected to the outlet of the first storage section 41 and another end connected to the inlet of the negative electrode compartment 61. The first liquid 12 is fed to the negative electrode compartment 61 from the first storage section 41 through the pipe 43.

The pipe 44 has an end connected to the outlet of the negative electrode compartment 61 and another end connected to the inlet of the first storage section 41. The first liquid 12 is fed to the first storage section 41 from the negative electrode compartment 61 through the pipe 44.

The pump 45 is disposed in the pipe 44. The pump 45 may be disposed in the pipe 43. The pump 45 pressurizes, for example, the first liquid 12. The flow rate of the first liquid 12 can be regulated by controlling the pump 45. The circulation of the first liquid 12 can be started or stopped with the pump 45. Incidentally, the flow rate of the first liquid 12 can be regulated with a member other than a pump. The member is, for example, a valve.

As described above, the first circulation mechanism 40 can circulate the first liquid 12 between the negative electrode compartment 61 and the first storage section 41. According to the first circulation mechanism 40, the amount of the first liquid 12 in contact with the negative electrode active material 14 can be readily increased. The contact time between the first liquid 12 and the negative electrode active material 14 can also be increased. Therefore, the oxidation reaction and reduction reaction of the first redox species 18 with the negative electrode active material 14 can be efficiently carried out.

The second circulation mechanism 50 includes a second storage section 51, a second filter 52, a pipe 53, a pipe 54, and a pump 55. The second storage section 51 stores the positive electrode active material 24 and the second liquid 22. In the inside of the second storage section 51, the positive electrode active material 24 is in contact with the second liquid 22. For example, the second liquid 22 is present in a cavity in the positive electrode active material 24. The second storage section 51 is, for example, a tank.

The second filter 52 is disposed at an outlet of the second storage section 51. The second filter 52 may be disposed at an inlet of the second storage section 51 or may be disposed at an inlet or outlet of the positive electrode compartment 62. The second filter 52 may be disposed in the pipe 53 as described below. The second filter 52 allows the second liquid 22 to pass therethrough and suppresses the passage of the positive electrode active material 24. When the positive electrode active material 24 is granular, the second filter 52 has, for example, pores smaller than the particle size of the positive electrode active material 24. The material of the second filter 52 is not particularly limited as long as the material is almost unreactive with the positive electrode active material 24 or the second liquid 22. Examples of the second filter 52 include glass fiber filter paper, polypropylene nonwoven fabrics, polyethylene nonwoven fabrics, and metal meshes unreactive with metallic lithium. According to the second filter 52, the leakage of the positive electrode active material 24 from the second storage section 51 can be suppressed. This allows the positive electrode active material 24 to remain in the second storage section 51. In the redox flow battery 100, the positive electrode active material 24 itself does not circulate. Therefore, the inside of the pipe 53 or the like is unlikely to be clogged with the positive electrode active material 24. According to the second filter 52, the occurrence of resistance loss due to the leakage of the positive electrode active material 24 into the positive electrode compartment 62 can also be suppressed.

The pipe 53 is connected to, for example, the outlet of the second storage section 51 with the second filter 52 therebetween. The pipe 53 has an end connected to the outlet of the second storage section 51 and another end connected to the inlet of the positive electrode compartment 62. The second liquid 22 is fed to the positive electrode compartment 62 from the second storage section 51 through the pipe 53.

The pipe 54 has an end connected to the outlet of the positive electrode compartment 62 and another end connected to the inlet of the second storage section 51. The second liquid 22 is fed to the second storage section 51 from the positive electrode compartment 62 through the pipe 54.

The pump 55 is disposed in the pipe 54. The pump 55 may be disposed in the pipe 53. The pump 55 pressurizes, for example, the second liquid 22. The flow rate of the second liquid 22 can be regulated by controlling the pump 55. The circulation of the second liquid 22 can be started or stopped with the pump 55. Incidentally, the flow rate of the second liquid 22 can be regulated with a member other than a pump. The member is, for example, a valve.

As described above, the second circulation mechanism 50 can circulate the second liquid 22 between the positive electrode compartment 62 and the second storage section 51. According to the second circulation mechanism 50, the amount of the second liquid 22 in contact with the positive electrode active material 24 can be readily increased. The contact time between the second liquid 22 and the positive electrode active material 24 can also be increased. Therefore, the oxidation reaction and reduction reaction of the second redox species 28 with the positive electrode active material 24 can be efficiently carried out.

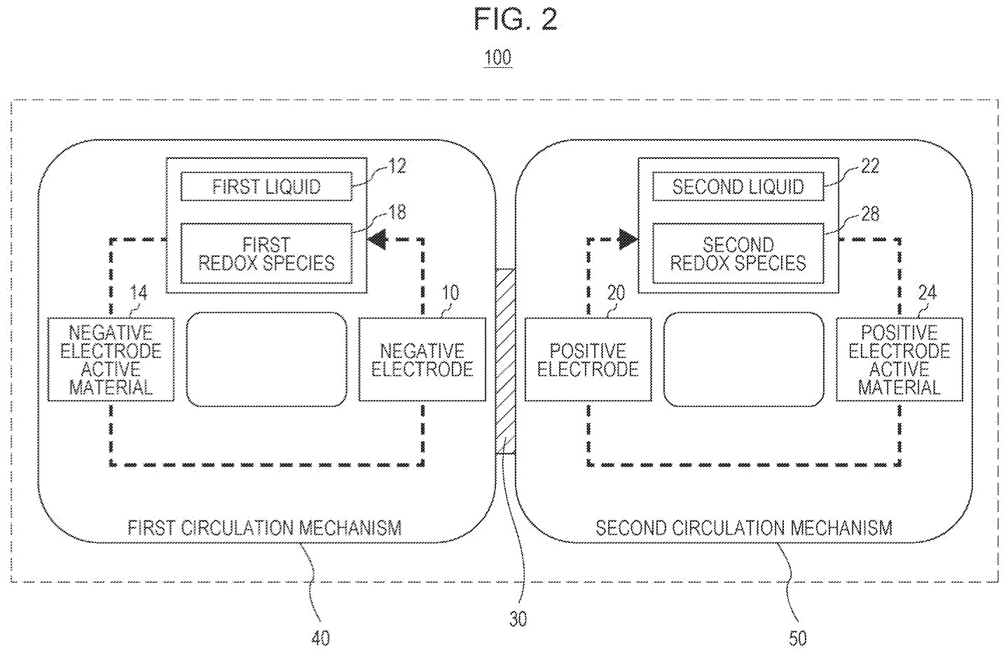

Next, an example of the operation of the redox flow battery 100 is described with reference to FIG. 2. FIG. 2 is an illustration showing the operation of the redox flow battery 100 shown in FIG. 1. In the description below, the first redox species 18 is referred to as “Md” in some cases. The negative electrode active material 14 is referred to as “NA” in some cases. In the description below, the second redox species 28 used is tetrathiafulvalene (hereinafter referred to as “TTF” in some cases). The positive electrode active material 24 used is lithium iron phosphate (LiFePO₄), In the description below, the metal ions are lithium ions.

### Charge Process of Redox Flow Battery

First, a voltage is applied between the negative electrode 10 and positive electrode 20 of the redox flow battery 100, whereby the redox flow battery 100 is charged. Reactions on the negative electrode 10 side and reactions on the positive electrode 20 side in a charge process are described below.

### Reactions on Negative Electrode Side

Electrons are supplied to the negative electrode 10 from outside the redox flow battery 100 by the application of voltage. This allows the first redox species 18 to be reduced on a surface of the negative electrode 10. The reduction reaction of the first redox species 18 is represented by, for example, a reaction equation below. Incidentally, lithium ions (Li⁺) are supplied from, for example, the second liquid 22 through the metal ion-conducting membrane 30.

Md+Li⁺+e⁻→Md.Li

In the above reaction equation, Md.Li is a composite of a lithium cation and the reduced first redox species 18. The reduced first redox species 18 contains an electron solvated with the solvent in the first liquid 12. As the reduction reaction of the first redox species 18 proceeds, the concentration of Md.Li in the first liquid 12 increases. The increase in the concentration of Md.Li in the first liquid 12 reduces the potential of the first liquid 12. The potential of the first liquid 12 is reduced to a value less than the maximum potential at which the negative electrode active material 14 can store lithium ions.

Next, Md.Li is fed to the negative electrode active material 14 by the first circulation mechanism 40. The potential of the first liquid 12 is lower than the maximum potential at which the negative electrode active material 14 can store lithium ions. Therefore, the negative electrode active material 14 receives a lithium ion and an electron from Md.Li. This oxidizes the first redox species 18 and reduces the negative electrode active material 14, This reaction is represented by, for example, a reaction equation below. Incidentally, in the reaction equation below, s and t are an integer of 1 or more.

sNA+tMd.Li→NAₛLiₜ+tMd

In the above reaction equation, NAₛLiₜ is a lithium compound formed as the negative electrode active material 14 stores lithium ions. When the negative electrode active material 14 contains graphite, s and tin the above reaction equation are, for example, 6 and 1, respectively. In this case, NAₛLiₜ is C₆Li. When the negative electrode active material 14 contains aluminium, tin, or silicon, s and t in the above reaction equation are, for example, 1. In this case, NAₛLiₜ is LiAl, LiSn, or LiSi.

Next, the first redox species 18 oxidized by the negative electrode active material 14 is fed to the negative electrode 10 by the first circulation mechanism 40. The first redox species 18 fed to the negative electrode 10 is reduced on the surface of the negative electrode 10 again. This produces Md.Li. As described above, the negative electrode active material 14 is charged by the circulation of the first redox species 18. That is, the first redox species 18 functions as a charge mediator.

### Reactions on Positive Electrode Side

The second redox species 28 is oxidized on a surface of the positive electrode 20 by the application of voltage. This allows electrons to be drawn from the positive electrode 20 to outside the redox flow battery 100. The oxidation reaction of the second redox species 28 is represented by, for example, reaction equations below.

TTF→TTF⁺+e⁻

TTF⁺→TTF²⁺e⁻

Next, the second redox species 28 oxidized on the positive electrode 20 is fed to the positive electrode active material 24 by the second circulation mechanism 50. The second redox species 28 fed to the positive electrode active material 24 is reduced by the positive electrode active material 24. On the other hand, the positive electrode active material 24 is oxidized by the second redox species 28. The positive electrode active material 24 oxidized by the second redox species 28 releases lithium ions. This reaction is represented by, for example, a reaction equation below.

LiFePO₄+TTF²⁺→FePO₄+Li⁺+TTF⁺

Next, the second redox species 28 reduced by the positive electrode active material 24 is fed to the positive electrode 20 by the second circulation mechanism 50. The second redox species 28 fed to the positive electrode 20 is oxidized on the surface of the positive electrode 20 again. This reaction is represented by, for example, a reaction equation below.

TTF⁺→TTF²⁺+e⁻

As described above, the positive electrode active material 24 is charged by the circulation of the second redox species 28. That is, the second redox species 28 functions as a charge mediator. Lithium ions (Li⁺) produced by the charge of the redox flow battery 100 move to, for example, the first liquid 12 through the metal ion-conducting membrane 30.

### Discharge Process of Redox Flow Battery

In the charged redox flow battery 100, electricity can be drawn from the negative electrode 10 and the positive electrode 20. Reactions on the negative electrode 10 side and reactions on the positive electrode 20 side in a discharge process are described below.

### Reactions on Negative Electrode Side

The first redox species 18 is oxidized on the surface of the negative electrode 10 by the discharge of the redox flow battery 100. This allows electrons to be drawn from the negative electrode 10 to outside the redox flow battery 100. The oxidation reaction of the first redox species 18 is represented by, for example, a reaction equation below.

Md.Li→Md Li⁺+e⁻

As the oxidation reaction of the first redox species 18 proceeds, the concentration of Md.Li in the first liquid 12 decreases. The decrease in the concentration of Md.Li in the first liquid 12 increases the potential of the first liquid 12. This allows the potential of the first liquid 12 to exceed the equilibrium potential of NAₛLiₜ.

Next, the first redox species 18 oxidized on the negative electrode 10 is fed to the negative electrode active material 14 by the first circulation mechanism 40. When the potential of the first liquid 12 is above the equilibrium potential of NAₛLiₜ, the first redox species 18 receives a lithium ion and an electron from NAₛLiₜ. This reduces the first redox species 18 and oxidizes the negative electrode active material 14. This reaction is represented by, for example, a reaction equation below. Incidentally, in the reaction equation below, s and t are an integer of 1 or more.

NAₛLiₜ+tMd→sNA+tMd.Li

Next, Md.Li is fed to the negative electrode 10 by the first circulation mechanism 40. Md.Li fed to the negative electrode 10 is oxidized on the surface of the negative electrode 10 again. As described above, the negative electrode active material 14 is discharged by the circulation of the first redox species 18. That is, the first redox species 18 functions as a discharge mediator. Lithium ions (Li⁺) produced by the discharge of the redox flow battery 100 move to, for example, the second liquid 22 through the metal ion-conducting membrane 30.

### Reactions on Positive Electrode Side

Electrons are supplied to the positive electrode 20 from outside the redox flow battery 100 by the discharge of the redox flow battery 100. This allows the second redox species 28 to be reduced on the surface of the positive electrode 20. The reduction reaction of the positive electrode 20 is represented by, for example, reaction equations below.

TTF²⁺+e⁻+TTF⁺

TTF⁺+e⁻→TTF

Next, the second redox species 28 reduced on the positive electrode 20 is fed to the positive electrode active material 24 by the second circulation mechanism 50. The second redox species 28 fed to the positive electrode active material 24 is oxidized by the positive electrode active material 24. On the other hand, the positive electrode active material 24 is reduced by the second redox species 28. The positive electrode active material 24 reduced by the second redox species 28 stores lithium ions. This reaction is represented by, for example, a reaction equation below. Incidentally, lithium ions (Li⁺) are supplied from, for example, the first liquid 12 through the metal ion-conducting membrane 30.

FePO₄+Li⁺+TTF→LiFePO₄+TTF⁺

Next, the second redox species 28 oxidized by the positive electrode active material 24 is fed to the positive electrode 20 by the second circulation mechanism 50. The second redox species 28 fed to the positive electrode 20 is reduced on the surface of the positive electrode 20 again. This reaction is represented by, for example, a reaction equation below,

TTF⁺+e⁻→TTF

As described above, the positive electrode active material 24 is discharged by the circulation of the second redox species 28. That is, the second redox species 28 functions as a discharge mediator.

In the redox flow battery 100 according to the present embodiment, the metal ion-conducting membrane 30 is nonporous. Therefore, the metal ion-conducting membrane 30 hardly allows the first redox species 18 and the second redox species 28 to pass therethrough. This enables a crossover that the first redox species 18 or the second redox species 28 moves between the first liquid 12 and the second liquid 22 to be suppressed. Suppressing the crossover enables the redox flow battery 100 to maintain high capacity over a long period of time.

The metal ion-conducting membrane 30 according to the present embodiment allows only metal ions that should be transferred to pass therethrough using the difference between the size of the metal ions that should be transferred and the size of the solvated first redox species 18 or second redox species 28. The metal ion-conducting membrane 30 itself hardly reduces ionic conductivity. Therefore, according to the metal ion-conducting membrane 30 of the present embodiment, an ionic conductivity almost equal to the ionic conductivity of an electrolyte solution itself can be achieved. That is, according to the metal ion-conducting membrane 30, a current can be drawn at a value sufficient for practical use.

When the metal ion-conducting membrane 30 contains a polyolefin or a fluorinated polyolefin as a major component, the metal ion-conducting membrane 30 is, for example, amorphous. In this case, the metal ion-conducting membrane 30 has few grain boundaries. Therefore, almost no local large current occurs during the operation of the redox flow battery 100. This allows few dendrites to occur in the metal ion-conducting membrane 30. According to the metal ion-conducting membrane 30, the redox flow battery 100 can be charged or discharged at high current density.

In the redox flow battery 100 according to the present embodiment, when the metal ion-conducting membrane 30 contains the polyolefin or the fluorinated polyolefin as a major component, the metal ion-conducting membrane 30 is unlikely to deteriorate even in a case where the first liquid 12 has low potential. Therefore, according to the metal ion-conducting membrane 30, the redox flow battery 100 can be achieved so as to have long life.

In the redox flow battery 100 according to the present embodiment, when the metal ion-conducting membrane 30 contains the polyolefin or the fluorinated polyolefin as a major component, the metal ion-conducting membrane 30 is almost insoluble in the first liquid 12 or the second liquid 22. Therefore, according to the metal ion-conducting membrane 30, the redox flow battery 100 can be achieved so as to have excellent charge/discharge characteristics.

### EXAMPLES

The present disclosure is further described below in detail with reference to examples. The present disclosure is not in any way limited to the examples. Many modifications can be made by those skilled in the art within the technical idea of the present disclosure.

### Preparation of First Liquid

First, a first redox species and an electrolyte salt were dissolved in a first nonaqueous solvent. The first redox species was biphenyl, the electrolyte salt was LiPF₆, and the first nonaqueous solvent was triglyme (triethylene glycol dimethyl ether). The concentration of biphenyl in the obtained solution was 0.1 mon. The concentration of LiPF₆ in the solution was 1 mol/L. An excess of metallic lithium was added to the solution. Metallic lithium was dissolved up to a saturation, whereby a biphenyl solution, saturated with lithium, having a dark blue color was obtained. The concentration of biphenyl in the solution did not vary before and after metallic lithium was dissolved in the solution. In the biphenyl solution, an excess of metallic lithium remained in the form of precipitate. The supernatant liquid of the biphenyl solution was collected, whereby a first liquid was obtained. Next, the size of biphenyl solvated with triglyme was calculated by first-principles calculation using the density functional method B3LYP/6-31G. The size of biphenyl solvated with triglyme was greater than or equal to 4 nm and less than or equal to 14 nm. The size of a cluster containing two molecules of biphenyl solvated with triglyme was greater than or equal to 8 nm and less than or equal to 28 nm. The size of a cluster containing four molecules of biphenyl solvated with triglyme was greater than or equal to 16 nm and less than or equal to 56 nm.

### Preparation of Second Liquid

First, a second redox species and an electrolyte salt were dissolved in a second nonaqueous solvent. The second redox species was tetrathiafulvalene, the electrolyte salt was LiPF₆, and the second nonaqueous solvent was triglyme. A second liquid was thus obtained. The concentration of tetrathiafulvalene in the second liquid was 5 mmol/L, The concentration of LiPF₆ in the second liquid was 1 mol/L. Next, the size of tetrathiafulvalene solvated with triglyme was calculated by first-principles calculation using the density functional method B3LYP/6-31G. The size of tetrathiafulvalene solvated with triglyme was greater than or equal to 4 nm and less than or equal to 15 nm. The size of a cluster containing two molecules of tetrathiafulvalene solvated with triglyme was greater than or equal to 8 nm and less than or equal to 30 nm. The size of a cluster containing four molecules of tetrathiafulvalene solvated with triglyme was greater than or equal to 16 nm and less than or equal to 60 nm.

### Configuration of Evaluation System

A metal ion-conducting membrane of Example 1, Example 2, or Comparative Example 1 described below was placed in an electrochemical cell. Into the electrochemical cell, 1 mL of each of the first liquid and the second liquid was poured such that first liquid and the second liquid were separated by the metal ion-conducting membrane. A negative electrode was immersed in the first liquid, and a positive electrode was immersed in the second liquid. The negative and positive electrodes used were made of stainless steel (SUS) foam. The open-circuit voltage (OCV) of the electrochemical cell was measured for 48 hours using an electrochemical analyzer.

### Example 1

First, an N-methylpyrrolidone (NMP) solution (produced by Kureha Corporation) containing polyvinylidene fluoride (PVDF) at a concentration of 8% by weight was prepared. Next, the NMP solution was applied to a glass plate, whereby a coating was obtained. The coating was dried at 80° C. for three hours in a thermostatic chamber and was further dried at 80° C. for three hours in a vacuum dryer. After drying, the coating was peeled away from the glass substrate, whereby a metal ion-conducting membrane was obtained. The metal ion-conducting membrane was a self-supporting film of PVDF, The thickness of the metal ion-conducting membrane was about 30 μm. The porosity of the metal ion-conducting membrane was 1%.

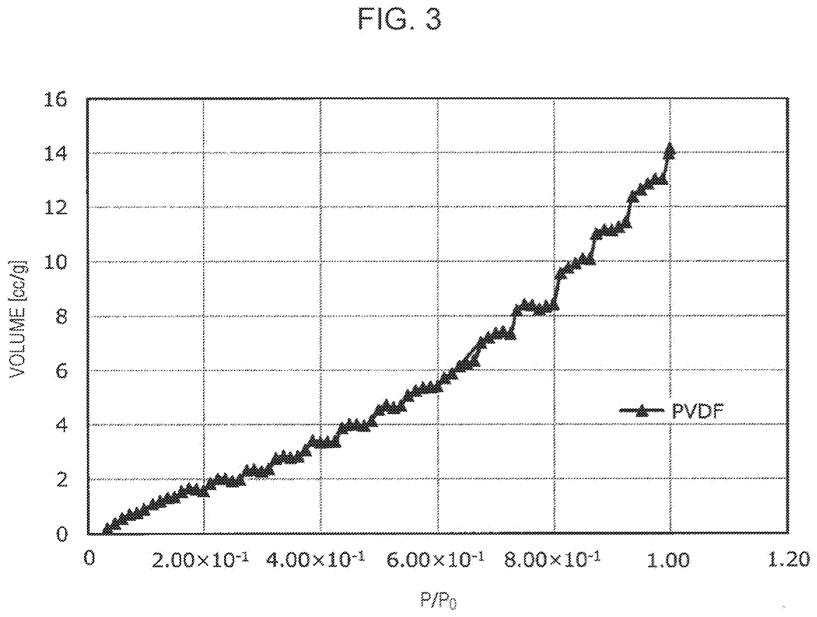

For the metal ion-conducting membrane of Example 1, a gas adsorption method was performed using a nitrogen gas, whereby an adsorption isotherm was obtained. FIG. 3 is a graph showing the adsorption isotherm of the nitrogen gas on the metal ion-conducting membrane of Example 1. The graph of FIG. 3 shows the relationship between the pressure of the nitrogen gas adsorbed on the metal ion-conducting membrane of Example 1 and the amount of the adsorbed nitrogen gas. As is clear from FIG. 3, the adsorption isotherm of the nitrogen gas on the metal ion-conducting membrane of Example 1 belonged to Type III according to the IUPAC classification. From the above, it was confirmed that the metal ion-conducting membrane of Example 1 was nonporous.

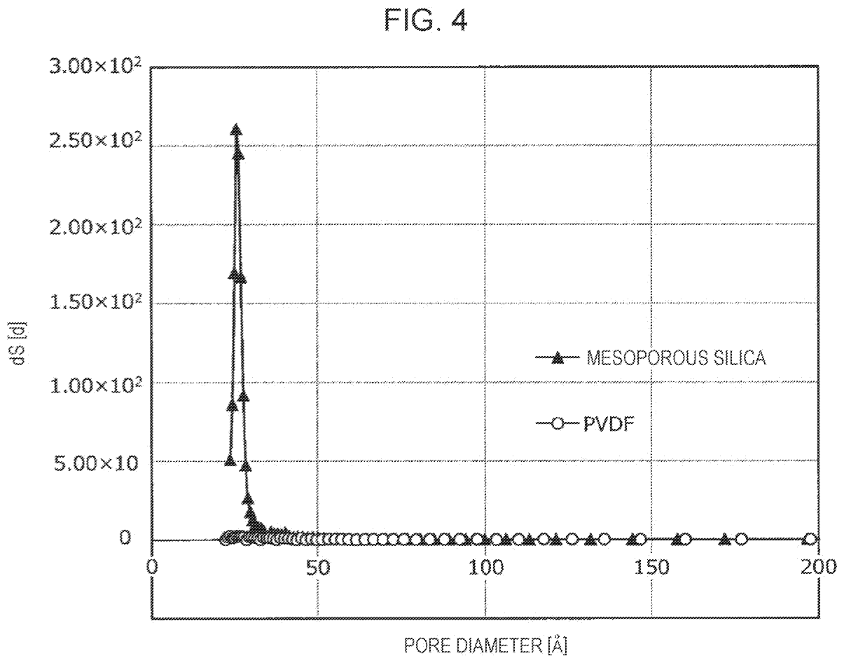

Next, a pore size distribution was obtained in such a manner that data on the adsorption isotherm of the nitrogen gas on the metal ion-conducting membrane of Example 1 was converted by the BJH technique. Next, the pore size distribution of mesoporous silica having through-pores with a diameter of 2.5 nm was obtained by the same method as that used for the metal ion-conducting membrane of Example 1. FIG. 4 is a graph showing the pore size distribution of the metal ion-conducting membrane of Example 1 and the pore size distribution of the mesoporous silica. As shown in FIG. 4, no peak indicating the presence of pores was observed in the pore size distribution of the metal ion-conducting membrane of Example 1. From the above, it was confirmed that the metal ion-conducting membrane of Example 1 was nonporous.

### Example 2

A metal ion-conducting membrane of Example 2 was obtained by the same method as that of Example 1 except that a nonwoven fabric was placed on a glass plate and the NMP solution was applied to the nonwoven fabric. The nonwoven fabric used was UOP13 manufactured by Hirose Paper Mfg Co., Ltd. In the metal ion-conducting membrane of Example 2, spaces between fibers of the nonwoven fabric were filled with PVDF. The thickness of the metal ion-conducting membrane of Example 2 was about 40 μm.

For the metal ion-conducting membrane of Example 2, a gas adsorption method was performed using a nitrogen gas, whereby an adsorption isotherm was obtained. The adsorption isotherm of the nitrogen gas on the metal ion-conducting membrane of Example 2 belonged to Type III according to the IUPAC classification. From the above, it was confirmed that the metal ion-conducting membrane of Example 2 was nonporous.

Furthermore, the pore size distribution of the metal ion-conducting membrane of Example 2 confirmed that the metal ion-conducting membrane was nonporous. The pore size distribution of the metal ion-conducting membrane was obtained in such a manner that data on an adsorption isotherm obtained by a gas adsorption method using a nitrogen gas was converted by the BJH technique.

### Comparative Example 1

A metal ion-conducting membrane used in Comparative Example 1 was a three-layer separator, made of polyolefin, for use in lithium ion batteries. The three-layer separator had through-pores. The average pore size of the three-layer separator was 150 nm. The average pore size of the three-layer separator was calculated from a pore size distribution that was obtained in such a manner that data on an adsorption isotherm obtained by a gas adsorption method using a nitrogen gas was converted by the BJH technique. The thickness of the three-layer separator was 20 μm.

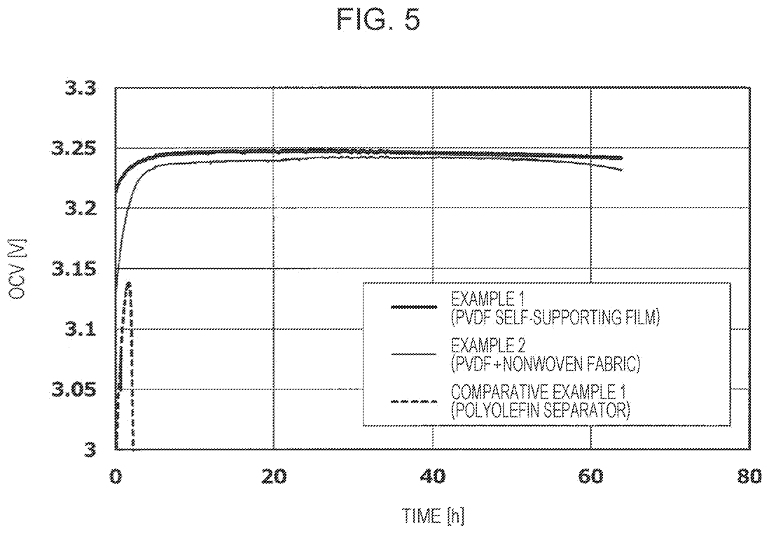

FIG. 5 is a graph showing the open-circuit voltage of the electrochemical cells of Example 1, Example 2, and Comparative Example 1, Table 1 shows a reduction in open-circuit voltage after 48 hours from the start of the measurement of the open-circuit voltage of the electrochemical cells of Example 1, Example 2, and Comparative Example 1.

TABLE 1

| | | Reduction in |
|---|---|---|
| | | open-circuit |
| | | voltage after |
| | Metal ion-conducting membrane | 48 hours [mV] |
| Example 1 | PVDF self-supporting film | 4 |
| Example 2 | PVDF coating | 1.7 |
| | (porous support: nonwoven fabric UOP13) | |
| Comparative | Three-layer separator made of polyolefin | 1,103 |
| Example 1 | (with through-pores) | |

In the electrochemical cells of Examples 1 and 2, the open-circuit voltage remained stable over 48 hours. This shows that, in the electrochemical cells of Examples 1 and 2, the crossover of biphenyl, which was the first redox species, and tetrathiafulvalene, which was the second redox species, was suppressed. On the other hand, in the electrochemical cell of Comparative Example 1, the open-circuit voltage decreased significantly. This suggests that, in the electrochemical cell of Comparative Example 1, the crossover of biphenyl, which was the first redox species, and tetrathiafulvalene, which was the second redox species, occurred. From the above, it is clear that using a self-supporting film or coating of PVDF as a metal ion-conducting membrane enables the above-mentioned crossover to be sufficiently suppressed.

A redox flow battery according to the present disclosure can be used as, for example, an electricity storage device or an electricity storage system.

What is claimed is:

1. A redox flow battery comprising:
a negative electrode;
a positive electrode;
a first liquid which contains a first nonaqueous solvent, a first redox species, and metal ions and which is in contact with the negative electrode;
a second liquid which contains a second nonaqueous solvent and which is in contact with the positive electrode; and
a metal ion-conducting membrane which is disposed between the first liquid and the second liquid and which is nonporous,
wherein the metal ion-conducting membrane is swollen by at least one selected from the group consisting of the first liquid and the second liquid and allows the metal ions to pass therethrough.

2. The redox flow battery according to claim 1, wherein an adsorption isotherm of a nitrogen gas on the metal ion-conducting membrane belongs to Type II or III according to the IUPAC classification.

3. The redox flow battery according to claim 1, wherein the metal ion-conducting membrane contains an organic polymer.

4. The redox flow battery according to claim 3, wherein the organic polymer includes at least one selected from the group consisting of polyolefins and fluorinated polyolefins.

5. The redox flow battery according to claim 3, wherein the organic polymer includes at least one selected from the group consisting of polyvinylidene fluoride, polyethylene, and polypropylene.

6. The redox flow battery according to claim 1, wherein the metal ions include at least one selected from the group consisting of lithium ions, sodium ions, magnesium ions, and aluminium ions.

7. The redox flow battery according to claim 1, further comprising:
a negative electrode active material in contact with the first liquid; and
a first circulation mechanism configured to circulate the first liquid between the negative electrode and the negative electrode active material,
wherein the first redox species is oxidized or reduced by the negative electrode and is oxidized or reduced by the negative electrode active material.

8. The redox flow battery according to claim 1, further comprising a negative electrode active material in contact with the first liquid,
wherein the first redox species is an aromatic compound,
the metal ions are lithium ions,
the first liquid dissolves lithium,
the negative electrode active material has a property of storing or releasing lithium ions,
the first liquid has a potential of less than or equal to 0.5 V vs. Li⁺/Li, and
the metal ion-conducting membrane contains an organic polymer as a major component.

9. The redox flow battery according to claim 8, wherein the aromatic compound includes at least one selected from the group consisting of biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, and benzil.

10. The redox flow battery according to claim 1, further comprising a positive electrode active material in contact with the second liquid,
wherein the second liquid contains a second redox species, and
the second redox species is oxidized or reduced by the positive electrode and is oxidized or reduced by the positive electrode active material.

11. The redox flow battery according to claim 10, wherein the second redox species includes at least one selected from the group consisting of tetrathiafulvalene, triphenylamine, and derivatives thereof.

12. The redox flow battery according to claim 1, wherein each of the first nonaqueous solvent and the second nonaqueous solvent includes a compound containing at least one selected from the group consisting of carbonate groups and ether bonds.

13. The redox flow battery according to claim 12, wherein each of the first nonaqueous solvent and the second nonaqueous solvent includes at least one selected from the group consisting of propylene carbonate, ethylene carbonate, dimethyl carbonate, ethyl methyl carbonate, and diethyl carbonate.

14. The redox flow battery according to claim 12, wherein each of the first nonaqueous solvent and the second nonaqueous solvent includes at least one selected from the group consisting of dimethoxyethane, diethoxyethane, dibutoxyethane, diglyme, triglyme, tetraglyme, polyethylene glycol dialkyl ethers, tetrahydrofuran, 2-methyltetrahydrofuran, 2,5-dimethyltetrahydrofuran, 1,3-dioxolane, and 4-methyl-1,3-dioxolane.
